(19) United States
(12) Patent Application Publication
(10) Pub. No.: US 2012/0222075 A1
(43) Pub. Date: Aug. 30, 2012

(54) METHOD, TERMINAL, AND SERVER FOR IMPLEMENTING FAST PLAYOUT

(75) Inventors: Guangyuan Liu, Shenzhen (CN); Teng Shi, Nanjing (CN); Weizhong Yuan, Shenzhen (CN); Renzhou Zhang, Nanjing (CN); Yuanyuan Zhang, Nanjing (CN); Yonghui Tian, Nanjing (CN); Peiyu Yue, Nanjing (CN); Chuxiong Zhang, Nanjing (CN)

(73) Assignee: Huawei Technologies Co., Ltd., Shenzhen (CN)

(21) Appl. No.: 13/466,624

(22) Filed: May 8, 2012

Related U.S. Application Data
(63) Continuation of application No. PCT/CN2010/075476, filed on Jul. 27, 2010.

(30) Foreign Application Priority Data
Nov. 9, 2009 (CN) 200910110045.3

(51) Int. Cl. H04N 21/6587

(52) U.S. Cl. 725/88

(57) ABSTRACT

A method for implementing fast playout is provided, which comprises: receiving a fast playout request sent by a client, where the fast playout request comprises a Uniform Resource Locator (URL) corresponding to content of a media file with a specified multiple of regular playout rate by the client, and the specified multiple of regular playout rate is determined by the client according to obtained media presentation description; and obtaining a content segment corresponding to the media file with the specified multiple of regular playout rate according to the URL, and sending a fast playout response to the client, where the fast playout response comprises the content segment corresponding to the media file with the specified multiple of regular playout rate. Therefore, fast online playing is implemented, and user experience is improved at the same time.

### CROSS-REFERENCE TO RELATED APPLICATIONS

This application is a continuation of International Application No. PCT/CN2010/075476, filed on Jul. 27, 2010, which claims priority to Chinese Patent Application No. 200910110045.3, filed on Nov. 9, 2009, both of which are hereby incorporated by reference in their entireties.

### FIELD OF THE INVENTION

The present invention relates to the field of communications technologies, and in particular, to a method, a terminal, and a server for implementing fast playout.

### BACKGROUND OF THE INVENTION

Users obtain and play multimedia content through a terminal device in many modes. Typical modes are playing files after downloading the files to a local disk through Hyper Text Transport Protocol (HTTP) or Peer to Peer (P2P) networking, playing and controlling streaming media through a conventional Real Time Protocol (RTP)/Real Time Control Protocol (RTCP) and a conventional Real Time Streaming Protocol (RTSP) for data transmission, online live broadcasting/on-demand broadcasting in a P2P streaming media manner, and HTTP progressive downloading.

During playing, the user may have many trick playing requirements on the playing modes, for example, operations such as fast-forward playing, fast-rewind playing, slow playing, slow replaying, sliding or dragging on a file being played. Basically, for files that are played after being downloaded to a local disk through the HTTP file downloading or P2P file downloading, the above various requirements on playing can all be implemented. However, the HTTP file downloading is inconvenient for the user. The HTTP file downloading requires that a requested media file should be downloaded to the local disk before being played, which is not applicable to the existing multimedia file that is usually with a size of hundreds of Megabytes, or even several Gigabits. In an existing network condition, the user needs to wait for a long time to finish the whole downloading process.

The online streaming service is a very popular broadcasting mode among users, since the online streaming service can be implemented without finishing downloading. However, the live broadcasting in the prior art fails to meet the playing requirements such as fast-forward playing or fast-rewind playing. For instance, in an application scenario, a user is watching a program of National Day military parade on an online streaming service website. The user is interested in troops of women soldiers, but does not know in which time period of the program the troops of women soldiers appear. Therefore, the user intends to perform fast playout so as to scan the program to determine the time period when the troops of women soldiers appear, and then perform normal playing to watch the troops of women soldiers. However, in the online streaming service of the prior art, the program being played can only be dragged, which fails to meet the fast playout requirement of the user.

### SUMMARY OF THE INVENTION

Accordingly, in order to implement fast-forward playing or fast-rewind playing during an online streaming service process, embodiments of the present invention provide a method, a terminal, and a server for fast-forward playing or fast-rewind playing.

A method for implementing fast playout provided in an embodiment of the present invention comprises:

receiving a fast playout request sent by a client, where the fast playout request comprises a Uniform Resource Locator (URL) corresponding to content of a media file with a specified multiple of regular playout rate by the client, and the specified playout rate is determined by the client according to obtained media presentation description; and obtaining a content segment corresponding to the media file with the specified multiple of regular playout rate according to the URL, and sending a fast playout response to the client, where the fast playout response comprises the content segment corresponding to the media file with the specified multiple of regular playout rate.

Meanwhile, a method for implementing fast playoutfast playout provided in an embodiment of the present invention comprises:

obtaining media presentation description of a media file from a server, where the media presentation description comprises a supported multiple of regular playout rate; specifying a multiple of regular playout rate according to the supported multiple of regular playout rate, and sending a fast playout request to the server, where the fast playout request comprises a URL corresponding to content of the media file with the specified multiple of regular playout rate; and receiving a fast playout response sent by the server, where the fast playout response comprises a content segment corresponding to the media file with the specified multiple of regular playout rate and implementing fast playout of the media file according to the content segment.

Meanwhile, a server for implementing fast playout provided in an embodiment of the present invention comprises:

a fast playout request receiving unit, configured to receive a fast playout request sent by a client, where the fast playout request comprises a URL corresponding to content of a media file with a specified multiple of regular playout rate by the client, and the specified multiple of regular playout rate is determined by the client according to obtained media presentation description; and a fast playout response sending unit, configured to obtain a content segment corresponding to the media file with the specified multiple of regular playout rate according to the URL, and send a fast playout response to the client, where the fast playout response comprises the content segment corresponding to the media file with the specified multiple of regular playout rate.

Meanwhile, a terminal for implementing fast playout provided in an embodiment of the present invention comprises: a media presentation description obtaining unit, configured to obtain media presentation description of a media file from a server, where the media presentation description comprises a supported multiple of regular playout rate; a fast playout request sending unit, configured to specify a multiple of regular playout rate according to the supported multiple of regular playout rate, and send a fast playout request to the server, where the fast playout request comprises a URL corresponding to content of a media file with the specified multiple of regular playout rate; and a fast playout response receiving unit, configured to receive a fast playout response sent by the server, where the fast playout response comprises a content segment corresponding to the media file with the specified multiple of regular playout rate, and implement fast playout of the media file according to the content segment.

In the embodiments of the present invention, the client sends the fast playout request to the server according to the supported multiple of regular playout rate comprised in the media presentation description of the media file. The server sends the fast playout response to the client, where the fast playout response carries the content segment corresponding to the media file with the specified multiple of regular playout rate. Therefore, the client may implement the required fast playout of the online streaming service according to each content segment, and improve user experience at the same time.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a flow chart of a method for implementing fast playout o f a media file according to an embodiment of the present invention;

FIG. 2 is a flow chart of another method for implementing fast playout of a media file according to an embodiment of the present invention;

FIG. 3 is a flow chart of another method for implementing fast playout of a media file according to an embodiment of the present invention;

FIG. 4 is a flow chart of another method for implementing fast playout of a media file according to an embodiment of the present invention;

FIG. 5 is a schematic diagram of a content segment of a media file according to an embodiment of the present invention;

FIG. 6 is a flow chart of another method for implementing fast playout of a media file according to an embodiment of the present invention;

FIG. 7 is a schematic diagram of another content segment of a media file according to an embodiment of the present invention;

FIG. 8 is a flow chart of another method for implementing fast playout of a media file according to an embodiment of the present invention;

FIG. 9 is a schematic diagram of another content segment of a media file according to an embodiment of the present invention;

FIG. 10 is a flow chart of another method for implementing fast playout of a media file according to an embodiment of the present invention;

FIG. 11 is a schematic diagram of another content segment of a media file according to an embodiment of the present invention;

FIG. 12 is a flow chart of another method for implementing fast playout of a media file according to an embodiment of the present invention;

FIG. 13 is a schematic structure diagram of a server for implementing fast playout according to an embodiment of the present invention;

FIG. 14 is a schematic structure diagram of another server for implementing fast playout according to an embodiment of the present invention; and

FIG. 15 is a schematic structure diagram of a terminal for implementing fast playout according to an embodiment of the present invention.

### DETAILED DESCRIPTION OF THE EMBODIMENTS

A method for multimedia fast-forward playing or fast-rewind playing of the present invention is an enhanced method based on an HTTP Streaming protocol of a streaming content transmission mode over HTTP. FIG. 1 is a method for a client implementing fast-forward playing or fast-rewind playing according to an embodiment of the present invention, where the method comprises the following steps.

Step 101: Receive a fast playout request sent by a client, where the fast playout request comprises a URL corresponding to content of a media file with a specified multiple of regular playout rate by the client, and the specified multiple of regular playout rate is determined according to media presentation description obtained by the client.

Step 102: Obtain a content segment corresponding to the media file with the specified multiple of regular playout rate according to the URL, and send a fast playout response to the client, where the fast playout response comprises the content segment corresponding to the media file with the specified multiple of regular playout rate.

In the embodiment of the present invention, the client sends the fast playout request to the server according to a supported multiple of regular playout rate comprised in the media presentation description of the media file. The server sends the fast playout response to the client, where the fast playout response carries the content segment corresponding to the media file with the specified multiple of regular playout rate. Therefore, the client may implement the required fast playout of the online streaming service according to each content segment, and improve user experience at the same time.

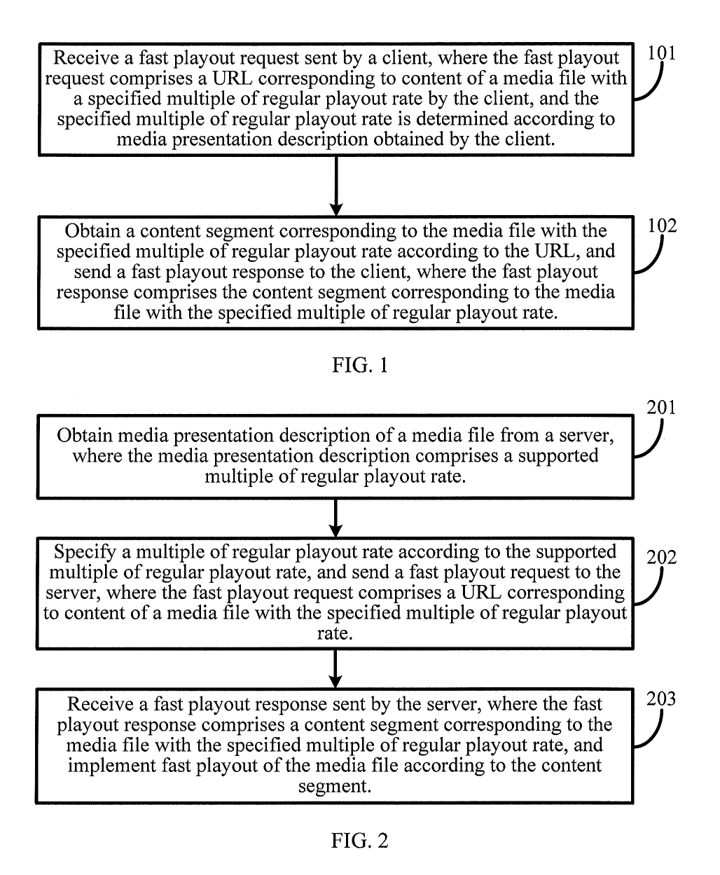

FIG. 2 is a method for a client implementing fast-forward playing or fast-rewind playing, where the method comprises the following steps.

Step 201: Obtain media presentation description of a media file from a server, where the media presentation description comprises a supported multiple of regular playout rate.

Step 202: Specify a multiple of regular playout rate according to the supported multiple of regular playout rate, and send a fast playout request to the server, where the fast playout request comprises a URL corresponding to content of a media file with the specified multiple of regular playout rate.

Step 203: Receive a fast playout response sent by the server, where the fast playout response comprises a content segment corresponding to the media file with the specified multiple of regular playout rate, and implement fast playout of the media file according to the content segment.

In the embodiment of the present invention, the client sends the fast playout request to the server according to the supported multiple of regular playout rate comprised in the media presentation description of the media file. The server sends the fast playout response to the client, where the fast playout response carries the content segment corresponding to the media file with the specified multiple of regular playout rate. Therefore, the client may implement the required fast playout of the online streaming service according to each content segment, and improve user experience at the same time.

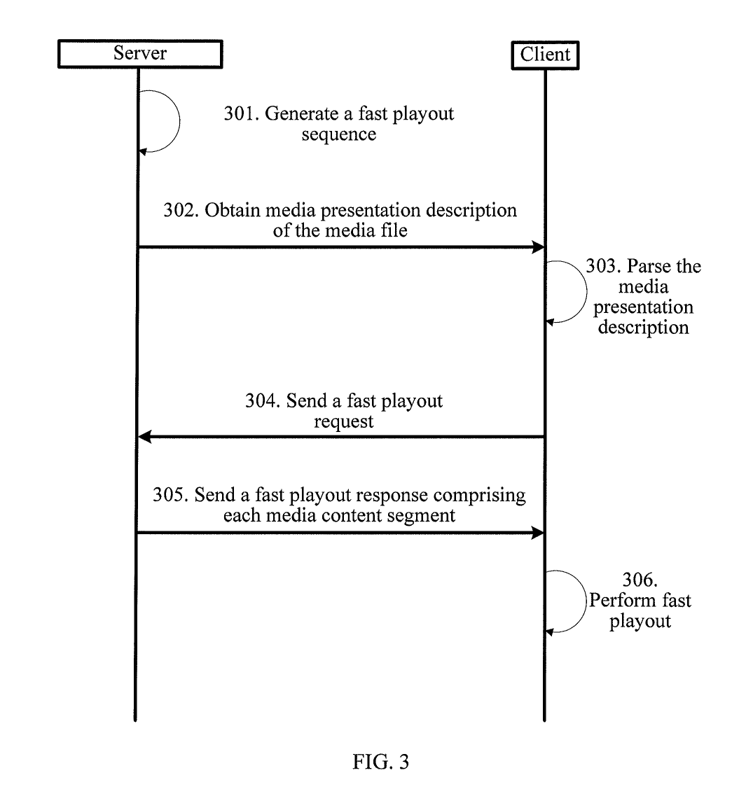

FIG. 3 is a method for implementing fast playout of a media file according to an embodiment of the present invention, where the method comprises the following steps.

Step 301: An HTTP Streaming server generates a fast playout sequence for a media file to be played in advance. Proper I frames are extracted from a regular playout rate sequence of the media file to establish an I frame index, and in combination with segments, the I frame index is encapsulated into a file meeting an HTTP Streaming requirement. The specific process is as follows: establishing in advance a pure I frame sequence for each multiple of regular playout rate of fast playout in a regular playout rate file of the media file, where the pure I frame sequence may be an actual I frame sequence or a virtual I frame sequence, namely, an I frame index file; and extracting the I frames when required.

Optionally, the HTTP Streaming server may also segment the fast playout sequence according to segment information of HTTP Streaming configuration of the file. The segment information may comprise: the number of segments of the file, a coding format of the file, and time of each segment of the file. Then, the server segments the fast playout sequence according to the segment information of the HTTP Streaming configuration of the file.

Optionally, the HTTP Streaming server may also encapsulate the segmented fast playout sequence into a file meeting the HTTP Streaming requirement, that is, meeting HTTP Streaming segmentation and file encapsulation characteristics. For example, the file after being encapsulated through the above method can meet a 3rd Generation Partnership Project (3GPP) standard format, or the file after being encapsulated through the above method can meet a Microsoft ISM file format, namely, a specific ISO file format capable of supporting a fragment form.

Through the above process, the HTTP Streaming server generates the fast playout sequence of the media file. At the same time, the HTTP Streaming server generates the media presentation description of the media file. The media presentation description comprises fast playout description, a supported multiple of regular playout rate of fast playout and different URLs corresponding to fast-forward playing or fast-rewind playing sequences with different multiples of regular playout rate.

Optionally, the media presentation description further comprises a URL corresponding to the fast playout sequence with a different multiple of regular playout rate. The URL may be directly linked to each segment of fast-forward playing or fast-rewind playing, or linked to a set of several segments of fast-forward playing or fast-rewind playing. For example, a segment set is downloaded directly through a URL of the segment set, or a URL of each segment in the set is obtained through the URL of the segment set.

Step 302: Before fast-forward playing or fast-rewind playing is requested, an HTTP Streaming client may obtain media presentation description from the server in multiple manners.

Step 303: The HTTP Streaming client parses the obtained media presentation description to obtain a fast playout Identifier (ID) of the media file and the supported multiple of regular playout rate of fast playout.

Step 304: After acquiring that the media file is capable of supporting fast playout and the supported multiple of regular playout rate of fast playout according to the media presentation description the HTTP Streaming client obtains a URL of a content segment corresponding to a specified multiple of regular playout rate of fast playout, and sends a fast playout request to the HTTP Streaming server according to the URL, where the fast playout request comprises the URL of the content segment corresponding to the specified multiple of regular playout rate of fast playout.

If the media presentation description does not comprise the URL of the content segment corresponding to each multiple of regular playout rate of fast playout, the client further needs to request the server for the URL of the content segment corresponding to each multiple of regular playout rate of fast playout.

Step 305: The HTTP Streaming server obtains each content segment according to the URL of the content segment corresponding to the specified multiple of regular playout rate of fast playout, and sends a fast playout response comprising each content segment to the client.

Step 306: The client implements fast playout of the content according to each content segment.

In the embodiment of the present invention, the client sends the fast playout request to the server according to the supported multiple of regular playout rate comprised in the media presentation description of the media file. The server sends the fast playout response to the client, where the fast playout response carries the content segments corresponding to the media file with the specified multiple of regular playout rate. Therefore, the client may implement the required fast playout of the online streaming service according to each content segment, and improve user experience at the same time.

Five different methods for fast playout are listed below. The five methods may have a same application scenario: all media files support fast playout, and the fast playout may be fast-forward playing or fast-rewind playing. Supported multiples of regular playout rate of fast-forward playing are 2×, 4×, and 8×; and supported multiples of regular playout rate of fast-rewind playing are −2×, −4×, and −8×, where × represents regular playout rate, and “−” represents rewinding. A content source is a 10-minute animated film, where a video code is a Moving Picture Experts Group-2 (MPEG-2) code, and an audio code is a Moving Picture Experts Group Audio Layer-3 (MP3) code.

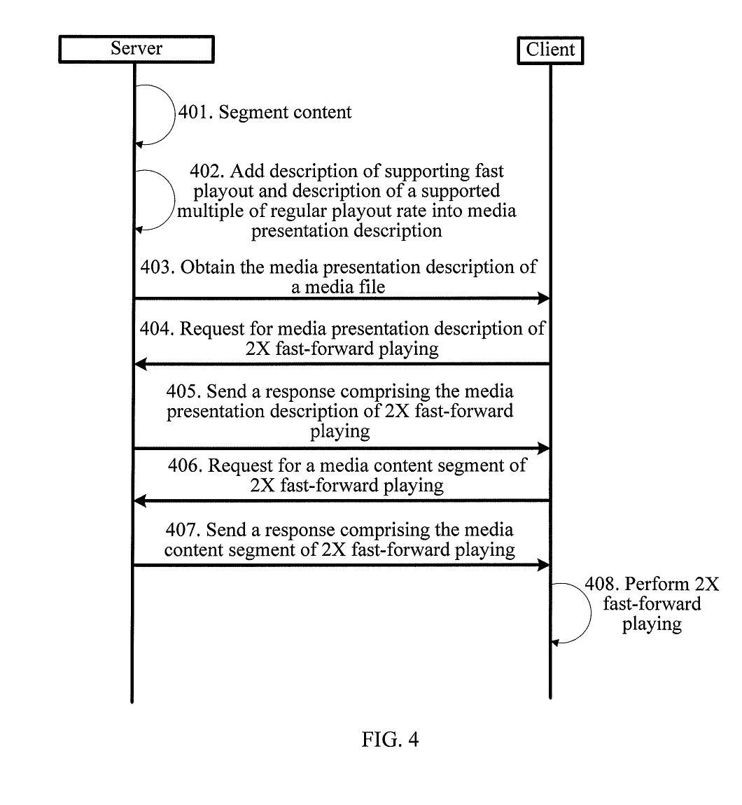

FIG. 4 is a method for implementing fast playout of a media file according to an embodiment of the present invention, where the method comprises the following steps.

Step 401: An HTTP Streaming server segments content to be fast played for a multimedia file.

For each multiple of regular playout rate of fast playout, the HTTP Streaming server needs to generate a corresponding fast playout sequence in advance. The fast playout sequence is generated from a regular playout rate sequence of the media file. For example, in a 2× fast-forward playing video sequence, I frames are extracted from an MPEG-2 code video at an interval of double of regular playout rate, and are re-coded in an original video coding format (MPEG-2) according to a video description parameter obtained from the MPEG-2 code video with the regular playout rate, thereby generating a video sequence only containing I frames at double of regular playout rate of fast-forward playing. Other modes for obtaining rate sequences are similar, that is, extracting I frames from an original video at an interval of N times of regular playout rate for re-coding, so as to obtain a video sequence operated at an interval of N times of regular playout rate. In a fast-rewind playing sequence, I frames are arranged in a reverse order.

Each fast playout sequence is segmented in a same way as the sequence with the same regular playout rate, and the segments are encapsulated in a 3GPP progressive file downloading format based on an ISO fragment format. In this manner, each file segment of fast playout can be decoded independently for playing. Since the segment of the fast playout sequence is the same as that of a regular playing sequence, a smooth switch can be performed between a fast playout operation and regular playing at a same segment time point. A specific segmentation method is described as follows.

The segmentation is performed based on a 10-second time interval. An audio and a video are segmented and encapsulated separately. In this manner, a 10-minute program is divided into 60 video segments with the regular playout rate and 60 audio segments with the regular playout rate.

When a Digital Versatile Disc (DVD) player or a video recorder in the prior art performs the fast playout operation, since the fast playout of the audio causes a change in pitch, generally the fast playout operation is performed on the video only, and the audio is processed in a mute manner. Therefore, the fast playout operation herein is merely a process based on the ISO fragment format for the video.

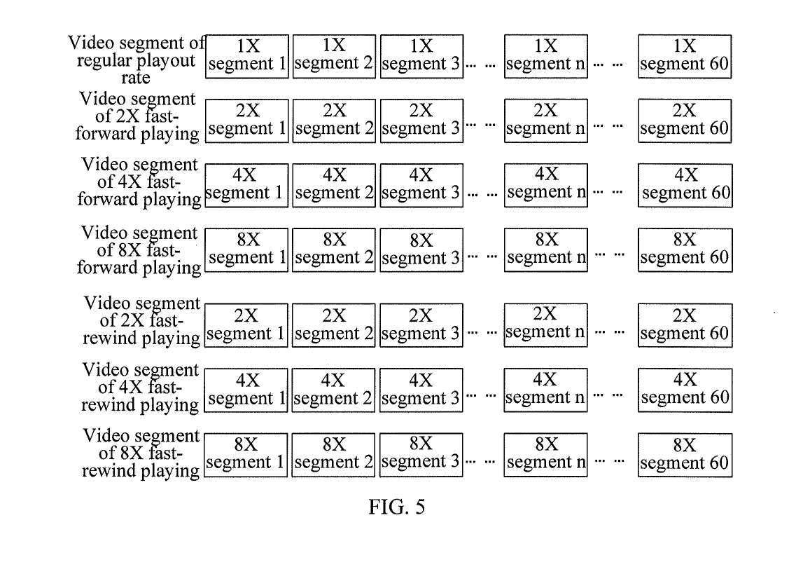

After encapsulating the segmented file according to the above mode, 60 fast-forward playing video segments with double of regular playout rate, 60 fast-forward playing video segments with quadruple of regular playout rate, 60 fast-forward playing video segments with octuple of regular playout rate, 60 fast-rewind playing video segments with double of regular playout rate, 60 fast-rewind playing video segments with quadruple of regular playout rate, and 60 fast-rewind playing video segments with octuple of regular playout rate can be obtained, as shown in FIG. 5.

Step 402: The HTTP Streaming server adds description of supporting fast playout and description of a supported multiple of regular playout rate into media presentation description of a media file.

The description of fast playout may be an ID indicating whether the fast playout is supported and an ID for supporting a fast playout type. For example, the ID for supporting a fast-forward playing type is F, and the ID for supporting a fast-rewind playing type is S.

For instance, content of the media presentation description is as follows, where an underlined part is the added description of the fast-forward playing or fast-rewind playing.

Version=“1”
Duration=“5965419999”
Chunks=“60”
Type=“video”,Code=“MPEG-2”,Bitrate=“1250000”,Width=“640”,Height=“480”,indexU

RL=HTTP://www.abc.com/sample1/video1X/index.des

Type=“aideo”,Code=“MP3”,Bitrate=“64000”,indexURL=HTTP://www.abc.com/sample

1/aideo1X/index.des

Type=“fast-forward”,Code=“MPEG-2”,Bitrate=“480000”,scale=2,indexURL=HTTP://w

ww.abc.com/sample1/ff2X/index.des

Type=“fast-forward”,Code=“MPEG-2”,Bitrate=“240000”,scale=4,indexURL=HTTP://w

ww.abc.com/sample1/ff4X/index.des

Type=“fast-forward”,Code=“MPEG-2”,Bitrate=“120000”,scale=8,indexURL=HTTP://w

ww.abc.com/sample1/ff8X/index.des

Type=“fast-rewind”,Code=“MPEG-2”,Bitrate=“480000”,scale=−2,indexURL=HTTP://w

ww.abc.com/sample1/fr2X/index.des

Type=“fast-rewind”,Code=“MPEG-2”,Bitrate=“240000”,scale=−4,indexURL=HTTP://w

ww.abc.com/sample1/fr4X/index.des

Type=“fast-rewind”,Code=“MPEG-2”,Bitrate=“120000”,scale=−8,indexURL=HTTP://w

ww.abc.com/sample1/fr8X/index.des

The indexURL above is a media description link. A client may obtain description of a URL of a specific segment according to the link. Definitely, the URL description of the specific segment may also be provided directly in the same media presentation description. The fast-forward playing with double of regular playout rate is taken as an example below. The content of each segment of HTTP://www.abc.com/sample1/ff4×/index.des is as follows:

Version=“1”
mediaID=FF2X
TotalDuration=“5965419999”
Duration=“100000000”
Chunks=“60”
Number=1,Duration=“100000000”,URL=HTTP://www.abc.com/sample1/ff2X/segment

_1.3GP

Number=2,Duration=“100000000”,URL=HTTP://www.abc.com/sample1/ff2X/segment

_2.3GP

...
Number=59,Duration=“100000000”,URL=HTTP://www.abc.com/sample1/ff2X/segmen

t_59.3GP

Number=60,Duration=“65419999”,URL=HTTP://www.abc.com/sample1/ff2X/segment

_60.3GP

Step 403: The client obtains the media presentation description of the media file.

The client may obtain the media presentation description of the media file through multiple modes, for example, through a web page or an Electronic Program Guide (EPG). The client parses the media presentation description, and may obtain a media presentation duration from the media presentation description, the fast-forward playing or fast-rewind playing being supported, and the supported multiple of regular playout rate.

Optionally, the media presentation description may further comprise a URL corresponding to a content segment of the media file with each multiple of regular playout rate.

Step 404: The client selects a 2× fast-forward playing operation. When the 2× fast-forward playing operation is clicked and performed, the client obtains a URL link corresponding to the media presentation description of 2× fast-forward playing through an indexURL corresponding to the 2× fast-forward playing, and initiates an HTTP get request according to the URL link, so as to request for obtaining the media presentation description of 2× fast-forward playing from a URL indicated by the indexURL.

Step 405: The server sends an HTTP response to the client to reply to the client with the media presentation description of 2× fast forwarding, where the HTTP response carries the media presentation description corresponding to the 2× fast-forward playing. The media presentation description corresponding to the 2× fast-forward playing comprises the URL corresponding to each content segment of the media file with double of regular playout rate.

Step 406: The client parses the media presentation description corresponding to the 2× fast-forward playing to obtain the URL corresponding to each specific media segment, and initiates the HTTP get request to the server, so as to request for obtaining a media content segment from a URL address corresponding to the specific media segment.

Optionally, if the media presentation description obtained by the client in step 403 comprises a URL corresponding to the content segment of the media file with each multiple of regular playout rate, steps 404 and 405 do not need to be executed, and step 406 is executed directly.

Step 407: The server sends the HTTP response to the client, where the HTTP response carries the content segment of the media file corresponding to the 2× fast-forward playing.

Step 408: The client performs the 2× fast-forward playing on the media file according to the obtained content segment.

A client player parses the media content segment of 2× fast-forward playing, and plays the media content of 2× fast-forward playing.

Optionally, steps 404 to 407 may be executed for multiple times. For example, the above media file is divided into 60 segments, and then the HTTP get request is sent to the server for 60 times to request URLs corresponding to the 60 segments respectively. The server returns the URLs corresponding to the 60 segments to the client respectively, and the client obtains the 60 segments from the server according to the URLs corresponding to the 60 segments. Definitely, according to actual requirements, the client may also select partial segment content.

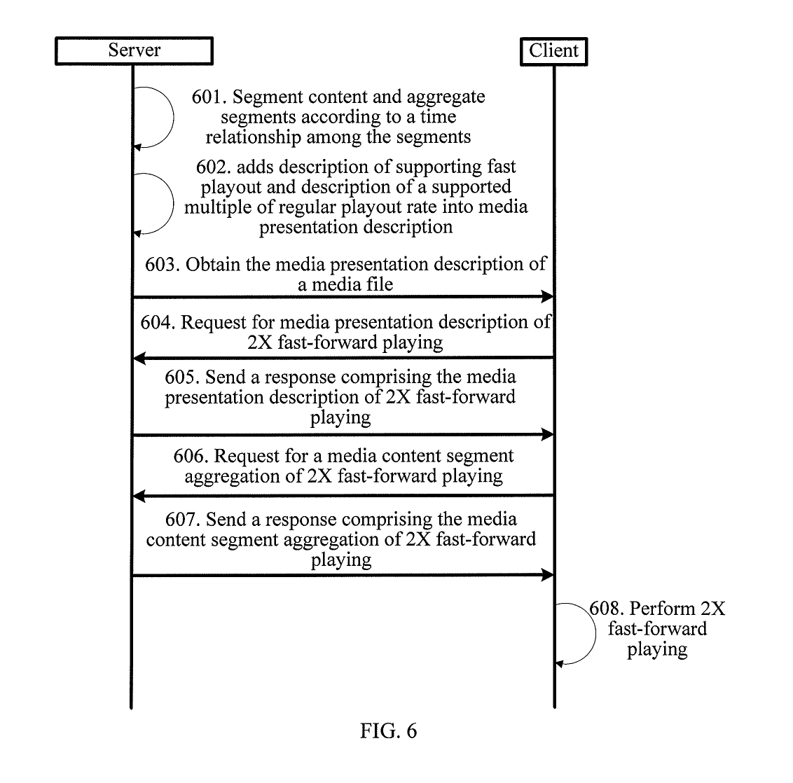

FIG. 6 is another method for implementing fast playout of a media file according to an embodiment of the present invention, where the method comprises the following steps.

Step 601: An HTTP Streaming server segments content to be fast played for a multimedia file, and aggregates segments according to a time relationship among the segments.

For each multiple of regular playout rate of fast playout, the HTTP Streaming server needs to generate a corresponding fast playout sequence in advance. The fast playout sequence is generated from a regular playout rate sequence of the media file. The generating mode is the same as that described in step 401.

Each fast playout sequence is segmented and encapsulated in the same mode as the embodiment corresponding to FIG. 4, for example, the segmentation is performed based on a 10-second time interval, and an audio and a video are segmented and encapsulated separately. In this manner, a 10-minute program is divided into 60 video segments with a regular playout rate and 60 audio segments with the regular playout rate.

The HTTP Streaming server may also aggregate a group of multiple proximate segments. For example, 6 proximate segments are aggregated as a group to obtain a segment aggregation file, and a piece of description information is added into a file header of the segment aggregation file to describe the segments in the segment set and a byte offset position of each segment.

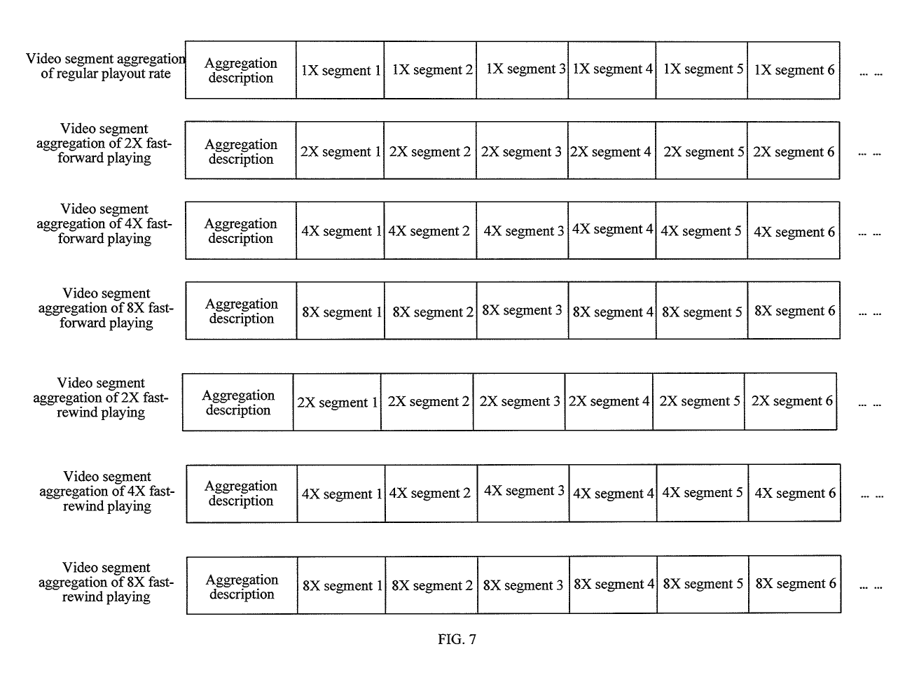

After the encapsulation and aggregation of the segment file are performed according to the above mode, 10 fast-forward playing video segment aggregations of double of regular playout rate, 10 fast-forward playing video segment aggregations of quadruple of regular-playout rate, 10 fast-forward playing video segment aggregations of octuple of regular playout rate, 10 fast-rewind playing video segment aggregations of double of regular playout rate, 10 fast-rewind playing video segment aggregations of quadruple of regular playout rate, and 10 fast-rewind playing video segment aggregations of octuple of regular playout rate are obtained, as shown in FIG. 7.

Step 602: The HTTP Streaming server adds description of supporting fast playout and description of a supported multiple of regular playout rate into media presentation description of a media file.

The description of fast playout may be an ID indicating whether the fast playout is supported and an ID for supporting a fast playout type. For example, the ID for supporting a fast-forward playing type is F, and the ID for supporting a fast-rewind playing type is S.

For instance, content of the media presentation description is as follows, where an underlined part is the description of the fast-forward playing or fast-rewind playing.

Version=“1”
Duration=“5965419999”
Chunks=“60”
Type=“video”,Code=“MPEG-2”,Bitrate=“1250000”,Width=“640”,Height=“480”,indexU

RL=HTTP://www.abc.com/sample1/video1X/index.des

Type=“aideo”,Code=“MP3”,Bitrate=“64000”,indexURL=HTTP://www.abc.com/sample

1/aideo1X/index.des

Type=“fast-forward”,Code=“MPEG-2”,Bitrate=“480000”,scale=2,indexURL=HTTP://w

ww.abc.com/sample1/ff2X/index.des

Type=“fast-forward”,Code=“MPEG-2”,Bitrate=“240000”,scale=4,indexURL=HTTP://w

ww.abc.com/sample1/ff4X/index.des

Type=“fast-forward”,Code=“MPEG-2”,Bitrate=“120000”,scale=8,indexURL=HTTP://w

ww.abc.com/sample1/ff8X/index.des

Type=“fast-rewind”,Code=“MPEG-2”Bitrate=“480000”,scale=−2,indexURL=HTTP://w

ww.abc.com/sample1/fr2X/index.des

Type=“fast-rewind”,Code=“MPEG-2”,Bitrate=“240000”,scale=−4,indexURL=HTTP://w

ww.abc.com/sample1/frb4X/index.des

Type=“fastr-rewind”,Code=“MPEG-2”,Bitrate=“120000”,scale=−8,indexURL=HTTP://

www.abc.com/sample1/fr8X/index.des

The indexURL above is a media description link. A client may obtain description of a URL of a specific segment according to the link. Definitely, the URL description of the specific segment may also be provided directly in the same media presentation description. The fast-forward playing with double of regular playout rate is taken as an example below. Aggregation content of 10 segments of HTTP://www.abc.com/sample1/ff4×/index.des is as follows:

Version=“1”
mediaID=FF2X
TotalDuration=“5965419999”
Duration=“600000000”
Chunks=“10”
Number=1,Duration=“600000000”,URL=HTTP://www.abc.com/sample1/ff2X/sa_1.sa
Number=2,Duration=“600000000”,URL=HTTP://www.abc.com/sample1/ff2X/sa_2.sa
...
Number=9,segmentDuration=“600000000”,URL=HTTP://www.abc.com/sample1/ff2X/s

a_9.sa

Number=10,segmentDuration=“65419999”,URL=HTTP://www.abc.com/sample1/ff2X/s

a_10.sa

Segment aggregation description of each segment aggregation file may be put into a header of the segment aggregation file. Definitely, the segment aggregation description may also be given directly in media aggregation description. Taking 2× fast-forward playing as an example, if a 0-1000B part of the header is the segment aggregation description, the aggregation description of a segment aggregation is as follows:

0001000-3000000B, 10S, segment_{—}1.3gp

3000000-6000000B, 10S, segment_{—}2.3gp

6000000-9000000B, 10S, segment_{—}3.3gp

0000001-3000000B, 10S, segment_{—}4.3gp

3000000-6000000B, 10S, segment_{—}5.3gp

6000000-9000000B, 10S, segment_{—}6.3gp

Step 603: The client obtains the media presentation description of the media file. The client may obtain the media presentation description of the media file through multiple modes, for example, through a web page or an EPG. The client parses the media presentation description, and may obtain a media presentation duration from the media presentation description the fast-forward playing or fast-rewind playing being supported, and the supported multiple of regular playout rate.

Optionally, the media presentation description may further comprise a URL corresponding to a content segment of the media file with each multiple of regular playout rate.

Step 604: The client selects a 2× fast-forward playing operation. When the 2× fast-forward playing operation is clicked and performed, the client obtains a URL link corresponding to the media presentation description of 2× fast-forward playing through an indexURL corresponding to the 2× fast-forward playing, and initiates an HTTP get request according to the URL link, so as to request for obtaining the media presentation description of 2× fast-forward playing from a URL indicated by the indexURL.

Step 605: The server sends an HTTP response to the client to return the media presentation description of 2× fast-forward playing to the client, where the HTTP response carries the media presentation description corresponding to the 2× fast-forward playing. The media presentation description corresponding to the 2× fast-forward playing comprises the URL corresponding to each content segment aggregation of the media file with double of regular playout rate.

Step 606: The client parses the media presentation description corresponding to the 2× fast-forward playing to obtain the URL corresponding to each specific media segment aggregation, and initiates the HTTP get request to the server, so as to request for obtaining a media content segment aggregation from a URL address corresponding to the specific media segment aggregation.

Specifically, the client obtains each segment through parsing the aggregation description in the header of the segment aggregation file.

If the client intends to obtain a specified segment quickly, the client may obtain the segment aggregation description through an HTTP partial obtaining request (indicating that the byte offset to be obtained in the header is 0-1000B), obtain the desired byte offset of the segment through parsing the segment aggregation description, and obtain the segment through the HTTP partial obtaining request (indicating the byte offset to be obtained).

Optionally, if the media presentation description obtained by the client in step 603 comprises a URL corresponding to the content segment of the media file with each multiple of regular playout rate, steps 604 and 605 do not need to be executed, and step 606 is executed directly.

Step 607: The server sends the HTTP response to the client, where the HTTP response carries the content segment aggregation of the media file corresponding to the 2× fast-forward playing.

Step 608: The client performs the 2× fast-forward playing on the media file according to the obtained content segment.

A client player parses the media content segment of 2× fast-forward playing, and plays the media content of 2× fast-forward playing.

Optionally, steps 604 to 607 may be executed for multiple times. For example, the above media file is divided into 10 segment aggregations, and then the HTTP get request needs to be sent to the server for 10 times to request URLs corresponding to the 10 segment aggregations separately. The server returns the URLs corresponding to the 10 segment aggregations to the client respectively, and the client obtains the 10 segments from the server respectively according to the URLs corresponding to the 10 segment aggregations. Definitely, according to actual requirements, the client may also select partial segment content. For example, the client may request for obtaining a second segment of a first segment aggregation only. The client obtains a byte offset of a header corresponding to the second segment of the first segment aggregation that needs to be obtained according to the segment aggregation description. The client sends an HTTP partial obtaining request to the server, where the HTTP partial obtaining request comprises the byte offset. The server returns a corresponding partial content segment aggregation to the client according to the byte offset.

Through the embodiment of the present invention, multiple file segments may be combined into a segment set file for storing. A piece of description information is added in the header of the segment aggregation file to describe the segments in the segment set and the byte offset position of each segment. In this manner, in general playing, the segment set file only needs to be obtained successively for playing, therefore reducing the HTTP requests and the load of the server. In special cases (dragging, or the beginning of file playing), the file may also be described through the header of the segment set file, so as to obtain the required byte offset of the segment. The required segment is obtained through the HTTP partial obtaining request. Through such flexible processing, the time for obtaining the file and the time delay are reduced.

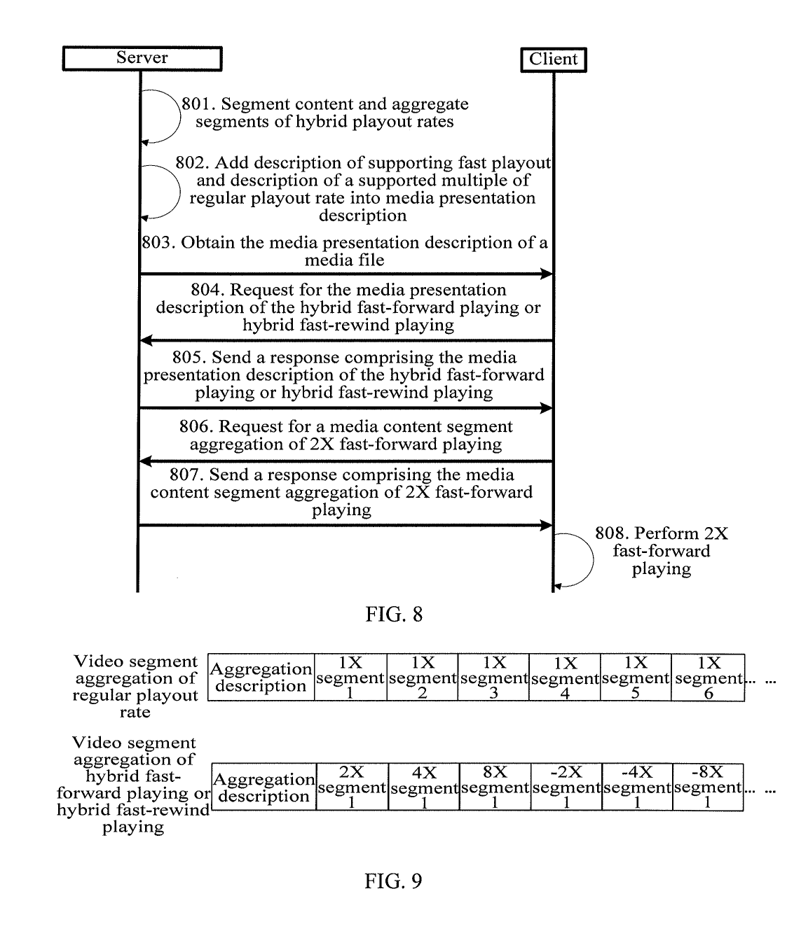

FIG. 8 shows another method for implementing fast playout of a media file according to an embodiment of the present invention, where the method comprises the following steps.

Step 801: An HTTP Streaming server segments content to be fast played for a multimedia file, and aggregates segments of hybrid playout rates.

For each multiple of regular playout rate of fast playout, the HTTP Streaming server needs to generate a corresponding fast playout sequence in advance. The fast playout sequence is generated from a regular playout rate sequence of the media file. The generating mode is the same as that described in step 401.

Each fast playout sequence is segmented and encapsulated in the same mode as the embodiment corresponding to FIG. 4, for example, the segmentation is performed based on a 10-second time interval, and an audio and a video are segmented and encapsulated separately. In this manner, a 10-minute program is divided into 60 video segments with a regular playout rate and 60 audio segments with the regular playout rate.

To reduce parsing of different rates of fast-forward playing or fast-rewind playing description caused by different multiples of regular playout rate, different rates of fast-forward playing or fast-rewind playing segments of different multiples of regular playout rate in a same time period may be aggregated. The aggregation may be performed according to the method described in step 601, so as to form a segment aggregation file. Moreover, the fast-forward playing or fast-rewind playing segments of different multiples of regular playout rate at the same time point are aggregated herein. For example, all segments at the start time with different multiples of regular playout rate are aggregated.

After the encapsulation and aggregation of the segment file are performed according to the above mode, 60 aggregations of fast-forward playing or fast-rewind playing video segments with hybrid playout rates are obtained, as shown in FIG. 9.

Step 802: The HTTP Streaming server adds description of supporting fast playout and description of a supported multiple of regular playout rate into media presentation description of a media file.

The description of fast playout may be an ID indicating whether the fast playout is supported and an ID for supporting a fast playout type. For example, the ID for supporting a fast-forward playing type is F, and the ID for supporting a fast-rewind playing type is S.

For instance, content of the media presentation description is as follows, where an underlined part is the description of the fast-forward playing or fast-rewind playing.

Version=“1”
Duration=“5965419999”
Chunks=“60”
Type=“video”,Code=“MPEG-2”,Bitrate=“1250000”,Width=“640”,Height=“480”,indexU

RL=HTTP://www.abc.com/sample1/video1X/index.des

Type=“aideo”,Code=“MP3”,Bitrate=“64000”,indexURL=HTTP://www.abc.com/sample

1/aideo1X/index.des

Type=“MIX”,Code=“MPEG-2”,Bitrate=“960000”,TrickMode=fast-forward,TrickMode=

fast-rewind,scale=2,scale=4,scale=8,scale=−2,scale=−4,scale=−8,indexURL=HTTP://www.abc.com/
sample1/MIX/index.des

The indexURL above is a media description link. A client may obtain description of a URL of a specific segment according to the link. Definitely, the URL description of the specific segment may also be provided directly in the same media presentation description. The content of the URL media presentation description of the specific segment with hybrid playout rates of fast playout is shown as follows:

Version=“1”
mediaID=MIX
TotalDuration=“5965419999”
Duration=“600000000”
Chunks=“60”
Number=1,Duration=“100000000”,URL=HTTP://www.abc.com/sample1/ff2X/sa_1.sa
Number=2,Duration=“100000000”,URL=HTTP://www.abc.com/sample1/ff2X/sa_2.sa
...
Number=59,segmentDuration=“100000000”,URL=HTTP://www.abc.com/sample1/ff2X

/sa_59.sa

Number=60,segmentDuration=“65419999”,URL=HTTP://www.abc.com/sample1/ff2X/s

a_60.sa

Segment aggregation description of each segment aggregation file may be put into a header of the segment aggregation file. Definitely, the segment aggregation description may also be given directly in media aggregation description. If a 0-1000B part of the header is the segment aggregation description, the aggregation description of a hybrid segment aggregation is as follows:

0001000-3000000B, 10S, 2×, segment_{—}1.3gp

3000000-6000000B, 10S, 4×, segment_{—}1.3gp

6000000-9000000B, 10S, 8×, segment_{—}1.3gp

0000001-3000000B, 10S, −2×, segment_{—}1.3gp

3000000-6000000B, 10S, −4×, segment_{—}1.3gp

6000000-9000000B, 10S, −8×, segment_{—}1.3gp

Step 803: The client obtains the media presentation description of the media file.

The client may obtain the media presentation description of the media file through multiple modes, for example, through a web page or an EPG. The client parses the media presentation description, and may obtain a media presentation duration from the media presentation description, the fast-forward playing or fast-rewind playing being supported, and the supported multiple of regular playout rate.

Optionally, the media presentation description may further comprise s URL corresponding to a content segment of the media file with each multiple of regular playout rate.

Step 804: The client selects a 2× fast-forward playing operation. When the 2× fast-forward playing operation is clicked and performed, the client obtains a URL link corresponding to the media presentation description of hybrid fast-forward playing or hybrid fast-rewind playing through an indexURL corresponding to the 2× fast-forward playing, and initiates an HTTP get request according to the URL link, so as to request for obtaining the media presentation description of the hybrid fast-forward playing or hybrid fast-rewind playing from a URL indicated by the indexURL.

Step 805: The server sends an HTTP response to the client to return the media presentation description of the hybrid fast-forward playing or hybrid fast-rewind playing to the client, where the HTTP response carries the media presentation description corresponding to the hybrid fast-forward playing or hybrid fast-rewind playing, and the media presentation description corresponding to the hybrid fast-forward playing or hybrid fast-rewind playing comprises the URL corresponding to each content segment aggregation of the media file with hybrid multiples of regular playout rate.

Step 806: The client parses the media presentation description corresponding to the hybrid fast-forward playing or hybrid fast-rewind playing to obtain the URL corresponding to a specific media segment aggregation of double of regular playout rate, and initiates the HTTP get request to the server, so as to request for obtaining a media content segment aggregation from a URL address corresponding to the specific media segment aggregation.

Optionally, if the media presentation description obtained by the client in step 803 comprises a URL corresponding to the content segment of the media file with each multiple of regular playout rate, steps 804 and 805 do not need to be executed, and step 806 is executed directly.

Step 807: The server sends the HTTP response to the client, where the HTTP response carries the content segment aggregation of the media file corresponding to the 2× fast-forward playing.

Step 808: The client performs the 2× fast-forward playing on the media file according to the obtained content segment.

A client player parses the media content segment of 2× fast-forward playing, and plays the media content of 2× fast-forward playing.

Optionally, steps 804 to 807 may be executed for multiple times. For example, the above media file is divided into 60 segment aggregations, and then the HTTP get request needs to be sent to the server for 60 times to request URLs corresponding to the 60 segment aggregations separately. The server returns the URLs corresponding to the 60 segment aggregations to the client respectively, and the client obtains the 60 segment aggregations from the server respectively according to the URLs corresponding to the 60 segment aggregations. Then, the client parses the aggregation description at the header of the segment aggregation file to obtain the byte offset of each segment aggregation and the multiple of regular playout rate of fast playout corresponding to each segment aggregation. The client obtains that the byte offset of double of regular playout rate of fast-forward playing segment is 0000001-3000000B through parsing the segment aggregation description, and obtains the double of regular playout rate of fast-forward playing segment through an HTTP partial obtaining request (indicating that the byte offset to be obtained is 0000001-3000000B). Definitely, according to actual requirements, the client may also select partial segment content. For example, the client may request for obtaining a second segment of a first segment aggregation only. The client obtains a byte offset of a header corresponding to the second segment of the first segment aggregation that needs to be obtained according to the segment aggregation description. The client sends an HTTP partial obtaining request to the server, where the HTTP partial obtaining request comprises the byte offset. The server returns a corresponding partial content segment aggregation to the client according to the byte offset.

Step 808: The client obtains each segment through parsing the aggregation description in the header of the segment aggregation file.

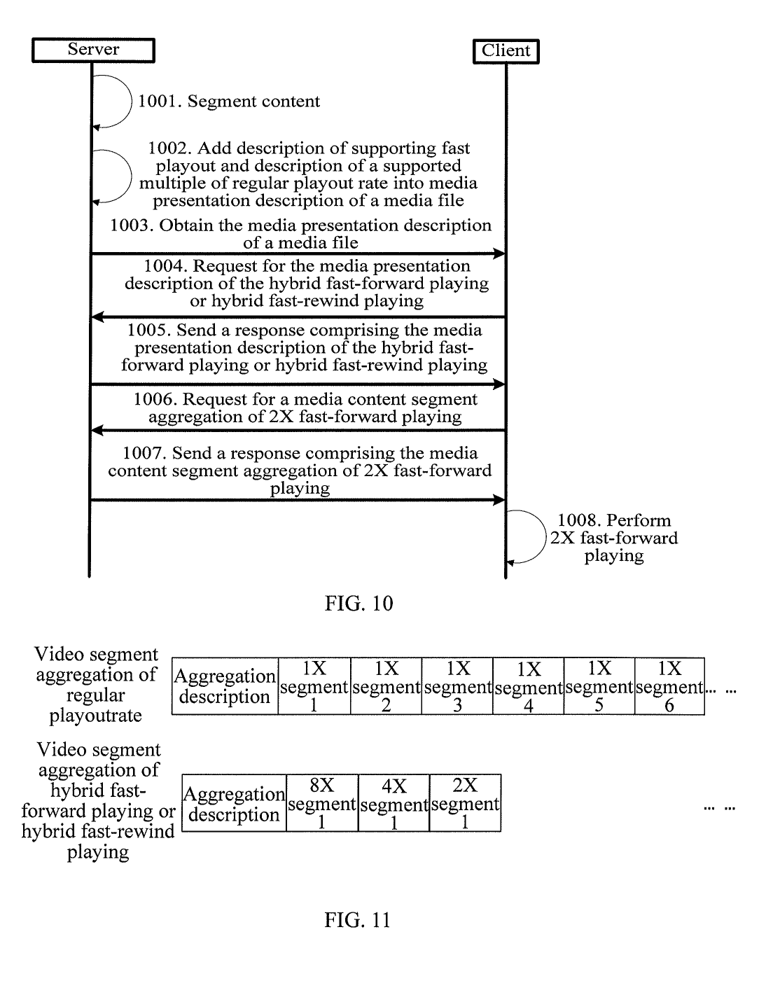

FIG. 10 shows another method for implementing fast playout of a media file according to an embodiment of the present invention, where the method comprises the following steps.

Step 1001: An HTTP Streaming server segments content to be fast played for a multimedia file.

For each multiple of regular playout rate of fast playout, the HTTP Streaming server needs to generate a corresponding fast playout sequence in advance. The fast playout sequence is generated from a regular playout rate sequence of the media file. The generating mode differs from that of step 401 in that, instead of generating a sequence corresponding to each multiple of regular playout rate through operation, only a hybrid fast playout sequence is generated. The mode for generating the sequence is described as follows.

I frames are extracted based on an interval of the minimal fast playout rate, and the minimal fast playout rate is 2× according to an application scenario of this embodiment, so as to obtain a hybrid I frame fast playout sequence of the regular playout rate. I frames are extracted from the hybrid I frame fast playout sequence for segmentation and encapsulation. Here, the segmentation is performed based on a 10-second time interval. The mode for extracting and encapsulating the I frames is described as follows.

Segments are encapsulated based on an ISO segment format. I frames required for a fast operation of a max playout rate are extracted from the hybrid fast playout sequence. According to the application scenario of this embodiment, the max playout rate is 8×, and the I frames are encapsulated into a playing segment of the max playout rate. Then, I frames required for a fast operation of a submaximal playout rate are extracted from the hybrid fast playout sequence. According to the application scenario of this embodiment, the submaximal playout rate of fast-forward playing or fast-rewind playing of this embodiment is 4×. Frames required for fast playout of a submaximal playout are eliminated, and the remaining frames are encapsulated into a fast playout segment of the submaximal playout rate. The encapsulation is performed in a similar manner until a fast playout segment of the minimal fast playout rate is encapsulated. If the fast playout rates are the same, it indicates that the I frames required are the same, and only the sequence is reverse. Therefore, the fast playout segments can be combined into one segment. An example is given below for illustration.

It is assumed that a time segment (10s) of regular playout rate comprises 16 I frames, which are {I1, I2, I3, I4, I5, I6, I7, I8, I9, I10, I11, I12, I13, I14, I15, I16} arranged in a time order. Then, the max playout rate of fast playout is octuple of regular playout rate, the I frames required are {I8, I16}, and the two frames are encapsulated into a fast playout segment of octuple of regular playout rate. The submaximal playout of fast playout is quadruple of regular playout rate, the I frames required are {I4, I8, I12, I16}, and after the I frames {I8, I16} required for the octuple of regular playout rate are eliminated, the remaining I frames are {I4, I12}, and the two frames are encapsulated into a fast playout segment of quadruple of regular playout rate. In a similar manner, the minimal playout rate of fast playout is double of regular playout rate, the I frames required are {I2, I4, I6, I8, I10, I12, I14, I16}, and after the I frames {I4, I8, I12, I16} required for the quadruple of regular playout rate are eliminated, the remaining I frames are {I2, I6, I10, I14}, and the four frames are encapsulated into a fast playout segment of double of regular playout rate.

Optionally, in the embodiment of the present invention, a hybrid aggregation may also be performed on the fast playout segments according to the method of the embodiment corresponding to FIG. 6. The fast playout segment of the max playout rate is put in the front, the segments are arranged in the order of rate levels, and the last segment of the segment aggregation is the fast playout segment of the minimal playout rate.

After the encapsulation and aggregation of the segment file are performed according to the above mode, 60 aggregations of fast-forward playing or fast-rewind playing video segments with hybrid playout rates are obtained, as shown in FIG. 11.

Step 1002: The HTTP Streaming server adds description of supporting fast playout and description of a supported multiple of regular playout rate into media presentation description of a media file.

The description of fast playout may be an ID indicating whether the fast playout is supported and an ID indicating a supported fast playout type. For example, the ID for supporting a fast-forward playing type is F, and the ID for supporting a fast-rewind playing type is S.

For instance, content of the media presentation description is as follows, where an underlined part is the description of the fast-forward playing or fast-rewind playing.

Version=“1”
Duration=“5965419999”
Chunks=“60”
Type=“video”,Code=“MPEG-2”,Bitrate=“1250000”,Width=“640”,Height=“480”,indexU

RL=HTTP://www.abc.com/sample1/video1X/index.des

Type=“aideo”,Code=“MP3”,Bitrate=“64000”,indexURL=HTTP://www.abc.com/sample

1/aideo1X/index.des

Type=“MIX”,Code=“MPEG-2”,Bitrate=“960000”,TrickMode=fast-forward,TrickMode=

fast-rewind,scale=2,scale=4,scale=8,scale=−2,scale=−4,scale=−8,indexURL=HTTP://www.abc.com/
sample1/MIX/index.des

The indexURL above is a media description link. A client may obtain description of a URL of a specific segment according to the link. Definitely, the URL description of the specific segment may also be provided directly in the same media presentation description. The content of the URL media presentation description of the specific segment with hybrid playout rates of fast playout is shown as follows:

Version=″1″
mediaID=MIX
TotalDuration=″5965419999″
Duration=″600000000″
Chunks=″60″
Number=1,Duration=”100000000”,URL=HTTP://www.abc.com/sample1/ff2X/sa_1.sa
Number=2,Duration=”100000000”,URL=HTTP://www.abc.com/sample1/ff2X/sa_2.sa
...
Number=59,segmentDuration=”100000000”,URL=HTTP://www.abc.com/sample1/ff2X

/sa_59.sa

Number=60,segmentDuration=”65419999”,URL=HTTP://www.abc.com/sample1/ff2X/

sa_60.sa

Segment aggregation description of each segment aggregation file may be put into a header of the segment aggregation file. Definitely, the segment aggregation description may also be given directly in media aggregation description. If a 0-1000B part of the header is the segment aggregation description, the aggregation description of a hybrid segment aggregation is as follows:

0000001-3000000B, 10S, +8×, −8×, segment_{—}1.3gp

3000000-6000000B, 10S, +4×, −4×, segment_{—}1.3gp

6000000-9000000B, 10S, +2×, −2×, segment_{—}1.3gp

Step 1003: The client obtains the media presentation description of the media file.

The client may obtain the media presentation description of the media file through multiple modes, for example, through a web page or an EPG. The client parses the media presentation description, and may obtain a media presentation duration from the media presentation description, the fast-forward playing or fast-rewind playing being supported, and the supported multiple of regular playout rate.

Optionally, the media presentation description may further comprise a URL corresponding to a content segment of the media file with each multiple of regular playout rate.

Step 1004: The client selects a 2× fast-forward playing operation. When the 2× fast-forward playing operation is clicked and performed, the client obtains a URL link corresponding to the media presentation description of the hybrid fast-forward playing or hybrid fast-rewind playing through an indexURL corresponding to the 2× fast-forward playing, and initiates an HTTP get request according to the URL link, so as to request for obtaining the media presentation description of the hybrid fast-forward playing or hybrid fast-rewind playing from a URL indicated by the indexURL.

Step 1005: The server sends an HTTP response to the client to return the media presentation description of the hybrid fast-forward playing or hybrid fast-rewind playing to the client, where the HTTP response carries the media presentation description corresponding to the hybrid fast-forward playing or hybrid fast-rewind playing, and the media presentation description corresponding to the hybrid fast-forward playing or hybrid fast-rewind playing comprises the URL corresponding to each content segment aggregation of the media file with the hybrid multiples of regular playout rate.

Step 1006: The client parses the media presentation description corresponding to the hybrid fast-forward playing or hybrid fast-rewind playing to obtain the URL corresponding to each specific media segment aggregation, and initiates the HTTP get request to the server, so as to request for obtaining a media content segment aggregation from a URL address corresponding to the specific media segment aggregation.

Specifically, the client obtains the URL corresponding to each specific media segment aggregation according to the media presentation description corresponding to the hybrid fast-forward playing or hybrid fast-rewind playing, and obtains segment aggregation description through an HTTP partial obtaining request (indicating that a byte offset to be obtained in the header is 0-1000B).

The client parses the aggregation description of the header of the segment aggregation file to obtain the byte offset of each segment and a multiple of regular playout rate of fast playout corresponding to each segment.

Through parsing the segment aggregation description, the byte offset of a segment required for fast-forward playing with double of regular playout rate is obtained. A segment of fast-forward playing with double of regular playout rate actually does not comprise all I frames required for the fast-forward playing with double of regular playout rate, and instead, a complete I frame sequence of fast-forward playing with double of regular playout rate can only be formed through combining I frames required for fast-forward playing with quadruple of regular playout rate. In a similar way, for a segment of fast-forward playing with quadruple of regular playout rate, a complete I frame sequence of fast-forward playing with quadruple of regular playout rate can only be formed through combining I frames required for fast-forward playing with octuple of regular playout rate. In a similar manner, the segments required for fast-forward playing with double of regular playout rate comprise: the segment of fast-forward playing with octuple of regular playout rate, the segment of fast-forward playing with quadruple of regular playout rate, and the segment of fast-forward playing with double of regular playout rate. Therefore, the byte offset of the segment aggregation that needs to be downloaded for the fast-forward playing with double of regular playout rate is 0000001-9000000B.

The segment of fast-forward playing with octuple of regular playout rate, the segment of fast-forward playing with quadruple of regular playout rate, and the segment of fast-forward playing with double of regular playout rate are obtained through the HTTP partial obtaining request (indicating that the byte offset to be obtained is 0000001-9000000B). I frames in these segments are extracted and arranged in a time order (for fast-rewind playing, the sequence is in a reverse order), so as to organize double of regular playout rate of fast-forward playing content in a media play format.

Optionally, if the media presentation description obtained by the client in step 1003 comprises a URL corresponding to the content segment of the media file with each multiple of regular playout rate, steps 1004 and 1005 do not need to be executed, and step 1006 is executed directly.

Step 1007: The server sends the HTTP response to the client, where the HTTP response carries the content segment aggregation of the media file corresponding to the 2× fast-forward playing.

Step 1008: The client performs the 2× fast-forward playing on the media file according to the obtained content segment.

A client player parses the media content of 2× fast-forward playing, and plays the media content of 2× fast-forward playing.

Through the above method, space required for fast playout segment may be saved and storage costs of the server are reduced.

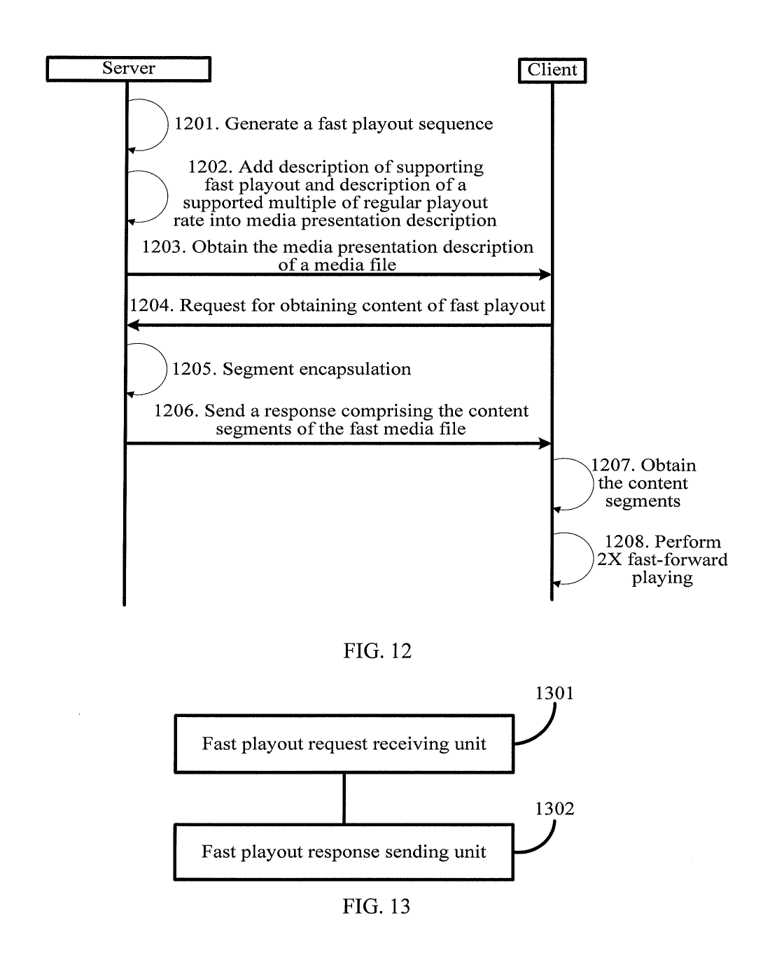

FIG. 12 shows another method for implementing fast playout of a media file according to an embodiment of the present invention, where the method comprises the following steps.

Step 1201: An HTTP Streaming server generates a fast playout sequence corresponding to content to be fast played for a multimedia file.

For each multiple of regular playout rate of fast playout, the HTTP Streaming server needs to generate a corresponding fast playout sequence in advance. The fast playout sequence is generated from a regular playout rate sequence of the media file. The generating mode herein is the same as step 401, but does not comprise the segmentation and encapsulation in step 401.

Step 1202: The HTTP Streaming server adds description of supporting fast playout and description of a supported multiple of regular playout rate into media presentation description of a media file.

The description of fast playout may be an ID indicating whether the fast playout is supported and an ID indicating a supported fast playout type. For example, the ID for supporting a fast-forward playing type is F, and the ID for supporting a fast-rewind playing type is S.

For instance, content of the media presentation description is as follows, where an underlined part is the description of the fast-forward playing or fast-rewind playing.

Version=“1”
Duration=“5965419999”
Chunks=“60”
Type=“video”,Code=“MPEG-2”,URL=“Levels({subtype})/{bitrate})/Fragments(video=

{start time})”>

subType=“normal”,Bitrate=“2500000”,Width=“720”,Height=“560”
subType=“normal”,Bitrate=“1250000”,Width=“640”,Height=“480”
subType=“normal”,Bitrate=“320000”,Width=“320”,Height=“240”
subType=“fast-forward”,Code=“MPEG-2”,Bltrate=“480000”,scale=2
subType=“fast-forward”,Code=“MPEG-2”,Bitrate=“240000”,scale=4
subType=“fast-forward”,Code=“MPEG-2”,Bitrate=“120000”,scale=8
subType=“fast-rewind”,Code=“MPEG-2”,Bitrate=“480000”,scale=−2
subType=“fast-rewind”,Code=“MPEG-2”,Bitrate=“240000”,scale=−4
subType=“fastr-rewind”,Code=“MPEG-2”,Bitrate=“120000”,scale=−8
Number=1,Duration=“100000000”
Number=2,Duration=“100000000”
...
Number=59,segmentDuration=“100000000”
Number=60,segmentDuration=“65419999”
Type=“aideo”,Code=“MP3”,Bitrate=“64000”,URL=“Levels({bitrate})/Fragments(video

={start time})”>

Step 1203: The client obtains the media presentation description of the media file.

The client may obtain the media presentation description of the media file through multiple modes, for example, through a web page or an EPG. The client parses the media presentation description, and may obtain a media presentation duration from the media presentation description, the fast-forward playing or fast-rewind playing being supported, and the supported multiple of regular playout rate.

Step 1204: The client selects a 2× fast-forward playing operation. When the 2× fast-forward playing operation is clicked and performed, description of a URL template in the media presentation description constructs a requested URL, where the URL comprises a server address and parameters of fast playout. For example, a URL of 2× fast-forward playing is HTTP://www.abc.com/samples1/serviceA/Levels(fast-forward)/Fragments(video=1200000000)?sca le=2, for requesting the 2× fast-forward playing operation of a service A (identified with HTTP://www.abc.com/samples1/serviceA/, and the media presentation description can be obtained through the URL). A start time point of requested 2× playing is at 120 second.

The client initiates an HTTP get request, and initiates a request to the above constructed URL to request for obtaining content of fast playout.

Step 1205: The server receives the HTTP get request and obtains the parameters from the URL, therefore obtaining information that the fast playout type is fast-forward playing, a playout rate is double of regular playout rate, and the start time point is 120 second. The server searches a 2× fast playout sequence according to the fast playout type and the playout rate, and searches I frames in the sequence that start at 120 second within an interval of 10 seconds according to the start time point. Then, the server performs segment encapsulation according to requirements, and puts the encapsulated segments in an HTTP response.

Step 1206: The server returns the HTTP response comprising the content segments of the media file to the client.

Step 1207: The client receives the HTTP response from the server, and obtains the media content segments from an HTTP load.

Step 1208: A client player parses the media content segment of 2× fast-forward playing, and plays the media content of 2× fast-forward playing.

FIG. 13 is a schematic structure diagram of a server for implementing fast playout according to an embodiment of the present invention, where the server comprises a fast playout request receiving unit 1301 and a fast playout response sending unit 1302.

The fast playout request receiving unit 1301 is configured to receive a fast playout request sent by a client, where the fast playout request comprises a URL corresponding to content of a media file with a specified multiple of regular playout rate by the client, and the specified multiple of regular playout rate is determined by the client according to obtained media presentation description.

The fast playout response sending unit 1302 is configured to obtain content segments corresponding to the media file with the specified multiple of regular playout rate according to the URL, and send a fast playout response to the client, where the fast playout response comprises the content segments corresponding to the media file with the specified multiple of regular playout rate.

In the embodiment of the present invention, the client sends the fast playout request to the server according to a supported multiple of regular playout rate comprised in the media presentation description of the media file. The server sends the fast playout response to the client, where the fast playout response carries the content segments corresponding to the media file with the specified multiple of regular playout rate. Therefore, the client may implement the required fast playout of the online streaming service according to each content segment, and improve user experience at the same time.

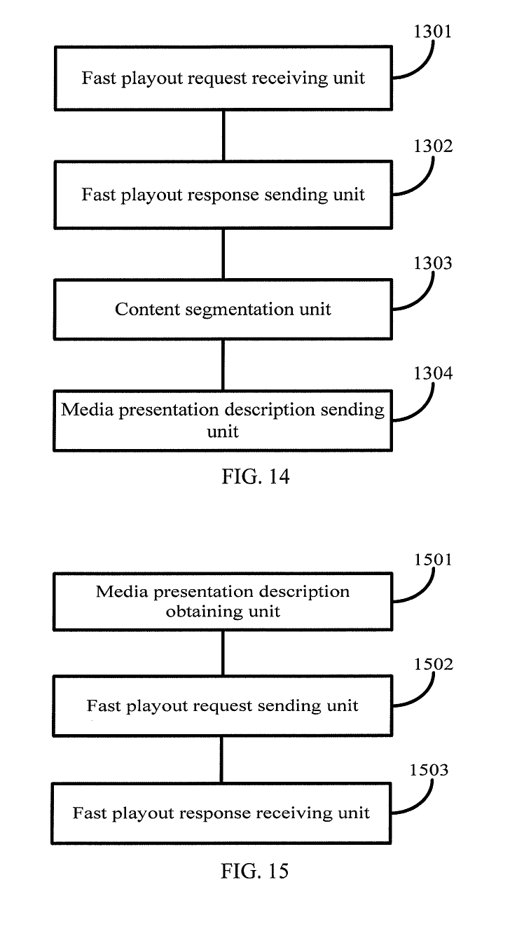

Optionally, as shown in FIG. 14, the server further comprises a content segmentation unit 1303 configured to extract corresponding I frames from a regular playout rate sequence of the media file according to the multiple of regular playout rate of fast playout, so as to generate a fast playout sequence and to encapsulate and segment the fast playout sequence according to an HTTP Streaming file format.

Optionally, as shown in FIG. 14, the server further comprises a media presentation description sending unit 1304 configured to send the media presentation description to the client, where the media presentation description comprises a fast playout type ID and a supported multiple of regular playout rate, so that the client specifies a fast playout type and a multiple of regular playout rate according to the fast playout type ID and the supported multiple of regular playout rate.

For the fast playout sequence, content segment, fast playout request, and related specific working processes involved in this embodiment, reference may be made to related contents disclosed in the embodiments with FIG. 3, FIG. 4, FIG. 6, FIG. 8, FIG. 10, and FIG. 12, and the details will not be repeated herein.

FIG. 15 is a schematic structure diagram of a terminal for implementing fast playout according to an embodiment of the present invention, where the terminal comprises a media presentation description obtaining unit 1501, a fast playout request sending unit 1502, and a fast playout response receiving unit 1503.

The media presentation description obtaining unit 1501 is configured to obtain media presentation description of a media file from a server, where the media presentation description comprises a supported multiple of regular playout rate.

The fast playout request sending unit 1502 is configured to specify a multiple of regular playout rate according to the supported multiple of regular playout rate, and send a fast playout request to the server, where the fast playout request comprises a URL corresponding to content of the media file with the specified multiple of regular playout rate.

The fast playout response receiving unit 1503 is configured to receive the fast playout response sent by the server, where the fast playout response comprises a content segment corresponding to the media file with the specified multiple of regular playout rate, and implement fast playout of the media file according to the content segment.

In the embodiment of the present invention, the client sends the fast playout request to the server according to the supported multiple of regular playout rate comprised in the media presentation description of the media file. The server sends the fast playout response to the client, where the fast playout response carries the content segments corresponding to the media file with the specified multiple of regular playout rate. Therefore, the client may implement the required fast playout of the online streaming service according to each content segment, and improve user experience at the same time.

For the fast playout sequence, content segment, fast playout request, and related specific working processes involved in this embodiment, reference may be made to related content disclosed in the embodiments with FIG. 3, FIG. 4, FIG. 6, FIG. 8, FIG. 10, and FIG. 12, and the details will not be repeated herein.

Through the description of the above implementation manner, persons skilled in the art may clearly know that the present invention may be realized by using software plus a necessary universal hardware platform, and may be definitely realized by using hardware, but under many situations, the former one is the most preferred implementation manner. Based on such understanding, the technical solutions of the present invention or parts of the technical solutions of the present invention making contributions to the prior art are substantially presented in the form of a software product. The software product is stored in a storage medium, which includes a plurality of instructions for enabling mobile equipment (such as a mobile phone, a personal computer, or a media player) to execute the methods according to the embodiments of the present invention. Here, the storage medium is, for example, a Read Only Memory (ROM) or Random Access Memory (RAM), a magnetic disk, or an optical disk.

It will be apparent to persons skilled in the art that various modifications and variations can be made to the present invention without departing from the scope and spirit of the invention. In view of the foregoing, it is intended that the present invention covers modifications and variations of this invention provided they fall within the scope of the following claims and their equivalents.

1. A method for implementing fast playout to construct fast-forward playing or fast-rewind playing, comprising:
receiving a fast playout request sent by a client, wherein the fast playout request comprises a Uniform Resource Locator (URL) corresponding to content of a media file with a specified multiple of regular playout rate by the client, and the specified multiple of regular playout rate is determined according to media presentation description obtained by the client; and
obtaining a content segment corresponding to the media file with the specified multiple of regular playout rat according to the URL, and sending a fast playout response to the client, wherein the fast playout response comprises the content segment corresponding to the media file with the specified multiple of regular playout rate.

2. The method according to claim 1, wherein the fast playout comprises fast-forward playing or fast-rewind playing.

3. The method according to claim 1, further comprising:
extracting I frames from a regular playout rate sequence of the media file according to a multiple of the regular playout rate of fast playout to generate a fast playout sequence; and
encapsulating and segmenting the fast playout sequence according to a Hyper Text Transport Protocol (HTTP) Streaming file format.

4. The method according to claim 3, further comprising one of: aggregating content segments of the media file for fast playout according to a time relationship among the content segments; or
aggregating the content segments of the media file for fast playout according to the time relationship among the content segments and multiples of regular playout rate of the content segments.

5. The method according to claim 3, wherein the extracting I frames from the regular playout rate sequence of the media file according to the multiple of regular playout rate of fast playout to generate the fast playout sequence file comprises:
storing I frames required by each multiple of regular playout rate of fast playout into a hybrid sequence;
extracting I frames required with a max playout rate from the hybrid sequence, and encapsulating the extracted I frames into a segment with the max playout rate; and
extracting I frames required with an n^{th} higher playout rate from the hybrid sequence, eliminating I frames required with a max playout rate prior to the n^{th} higher playout rate from the extracted I frames required with the n^{th} higher playout rate, and encapsulating the remaining frames into a segment of the n^{th} higher playout rate, wherein n is a natural number greater than 2.

6. The method according to claim 4, wherein the obtaining the content segment corresponding to the media file with the specified multiple of regular playout rate according to the URL, and sending the fast playout response to the client, wherein the fast playout response comprises the content segment corresponding to the media file with the specified multiple of regular playout rate specifically comprises:
obtaining a content segment aggregation corresponding to the media file with the specified multiple of regular playout rate according to the URL, and sending a fast playout response to the client, wherein the fast playout response comprises the content segment aggregation corresponding to the media file with the specified multiple of regular playout rate.

7. The method according to claim 1, further comprising: sending the media presentation description of the media file to the client, wherein the media presentation description comprises a fast playout type Identifier (ID) and a supported multiple of regular playout rate, so that the client specifies a fast playout type and a multiple of regular playout rate according to the fast playout type ID and the supported multiple of regular playout rate.

8. The method according to claim 3, wherein the URL corresponding to the content of the media file with the specified multiple of regular playout rate by the client is specifically a URL of each segment corresponding to the content of the media file with the specified multiple of regular playout rate by the client, and
the obtaining the content segment corresponding to the media file with the specified multiple of regular playout rate according to the URL comprises:
obtaining each content segment corresponding to the media file with the specified multiple of regular playout rate according to the URL of each segment;
alternatively, the URL corresponding to the content of the media file with the specified multiple of regular playout rate by the client is specifically a URL of a start segment corresponding to the content of the media file with the specified multiple of regular playout rate by the client, and
the obtaining the content segment corresponding to the media file with the specified multiple of regular playout rate according to the URL comprises:
obtaining each content segment corresponding to the media file with the specified multiple of regular playout rate according to the URL of the start segment, time of the start segment, and a time length between the segments, wherein the playing request further comprises the time of the start segment and the time length between the segments.

9. A method for implementing fast playout, comprising:
obtaining media presentation description of a media file from a server, wherein the media presentation description comprises a supported multiple of regular playout rate;
specifying a multiple of regular playout rate according to the supported multiple of regular playout rate, and sending a fast playout request to the server, wherein the fast playout request comprises a Uniform Resource Locator (URL) corresponding to content of a media file with the specified multiple of regular playout rate; and
receiving a fast playout response sent by the server, wherein the fast playout response comprises a content segment corresponding to the media file with the specified multiple of regular playout rate, and implementing fast playout of the media file according to the content segment.

10. The method according to claim 9, wherein the fast playout comprises fast-forward playing or fast-rewind playing.

11. The method according to claim 9, wherein the media presentation description further comprises a fast playout type; and
the specifying the multiple of regular playout rate according to the supported multiple of regular playout rate, and sending the fast playout request to the server, wherein the fast playout request comprises the URL corresponding to the content of the media file with the specified multiple of regular playout rate comprises:
specifying a multiple of regular playout rate and a fast playout type according to the supported multiple of regular playout rate and the fast playout type, and sending the fast playout request to the server, wherein the fast playout request comprises the URL corresponding to the content of the media file with the specified fast playout type and multiple of regular playout rate.

12. The method according to claim 9, wherein the content segment corresponding to the media file with the specified multiple of regular playout rate is specifically a content segment aggregation corresponding to the media file with the specified multiple of regular playout rate; and
the implementing the fast playout of the media file according to the content segment comprises:
obtaining segment aggregation description from the server, obtaining a desired byte offset of the segment through parsing the segment aggregation description, obtaining each content segment according to the byte offset of the segment, and implementing fast playout of the media file according to each content segment.

13. A server for implementing fast playout, comprising:
a fast playout request receiving unit, configured to receive a fast playout request sent by a client, wherein the fast playout request comprises a Uniform Resource Locator (URL) corresponding to content of a media file with a specified multiple of regular playout rate by the client, and the specified multiple of regular playout rate is determined by the client according to obtained media presentation description; and
a fast playout response sending unit, configured to obtain a content segment corresponding to the media file with the specified multiple of regular playout rate according to the URL, and send a fast playout response to the client, wherein the fast playout response comprises the content segment corresponding to the media file with the specified multiple of regular playout rate.

14. The server according to claim 13, further comprising:
a content segmentation unit, configured to extract I frames from a regular playout rate sequence of the media file according to a multiple of the regular playout rate of fast playout to generate a fast playout sequence, and encapsulate and segment the fast playout sequence according to a Hyper Text Transport Protocol (HTTP) Streaming file format.

15. The server according to claim 13, further comprising:
a media presentation description sending unit, configured to send the media presentation description to the client, wherein the media presentation description comprises a fast playout type Identifier (ID) and a supported multiple of regular playout rate, so that the client specifies a fast playout type and a multiple of regular playout rate according to the fast playout type ID and the supported multiple of regular playout rate.

16. A terminal for implementing fast playout, comprising:
a media presentation description obtaining unit, configured to obtain media presentation description of a media file from a server, wherein the media presentation description comprises a supported multiple of regular playout rate;
a fast playout request sending unit, configured to specify a multiple of regular playout rate according to the supported multiple of regular playout rate and send a fast playout request to the server, wherein the fast playout request comprises a Uniform Resource Locator (URL) corresponding to content of a media file with the specified multiple of regular playout rate; and
a fast playout response receiving unit, configured to receive the fast playout response sent by the server, wherein the fast playout response comprises a content segment corresponding to the media file with the specified multiple of regular playout rate, and implement fast playout of the media file according to the content segment.
